(19) United States
(12) Patent Application Publication
(10) Pub. No.: US 2009/0044281 A1
(43) Pub. Date: Feb. 12, 2009

(54) JAVA CONDITIONAL ACCESS APPARATUS

(75) Inventors: Yoshio Kawakami, Osaka (JP); Takakazu Shiomi, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/815,122

(22) PCT Filed: Feb. 1, 2006
(86) PCT No.: PCT/JP2006/301684

§ 371 Date: Jul. 31, 2007

(30) Foreign Application Priority Data
Feb. 1, 2005 (JP) 2005-025402

(51) Int. Cl. G06F 21/00; H04L 9/06

(52) U.S. Cl. 726/27; 380/44

(57) ABSTRACT

There is provided a Java™ conditional access apparatus which, by describing a CA control unit through a Java™ program, obviates the need for porting a CA control program, enables development of a CA system over plural terminals in a short time, and obviates the need for terminal replacement. The Java™ conditional access apparatus includes a descramble circuit, a key generation information obtaining library, a Java™ VM, a storage unit, a condition-release control unit, an API having a registration unit. Upon receiving a function from a CA control program, the registration unit registers the received function. When the API receives information of a channel, the information of the channel to be reproduced is notified to the CA control program. The CA control program requests the key generation information obtaining library to obtain key generation information corresponding to the received channel information, and passes the received key generation information to the condition-release control unit.

### TECHNICAL FIELD

The present invention relates to a conditional access system apparatus which uses Java™, and particularly to an apparatus which uses Java™ for descrambling of scrambled video and audio.

### BACKGROUND ART

At present, in order to provide high value-added contents through paid broadcasts, video and audio are scrambled and broadcast, and a digital television having a built-in conditional access apparatus with which only a contracting viewer can view descrambled video and audio is implemented.

An example is described in Japanese Unexamined Patent Application Publication no. 2000-295541 “Broadcast Receiving Apparatus, Broadcast Receiving Apparatus Contract Information Processing Method, and Broadcast Receiver Contract Information Processing Program Recording Medium”.

FIG. 1 is a block diagram showing the configuration of a conventional conditional access apparatus. An input unit 2701 is configured of a remote control, front panel, and the like, and accepts a channel selection from an input. Upon receiving a notification of the channel selected by a user from the input unit 2701, a control unit 2702 instructs a receiving unit 2703 to tune to a frequency corresponding to the channel. The receiving unit 2703 tunes to the frequency specified by the control unit 2702, and passes a received stream to a demultiplex unit 2704. The control unit 2702 receives, from the demultiplex unit 2704, information for reproducing the channel notified by the input unit 2701 from the demultiplex unit 2704. More specifically, it receives information on an identifier of the video and audio included in the stream as well as the presence/absence of scrambling. When the target channel is scrambled, the control unit 2702 requests descrambling to a CA control 2705. The CA control 2705 retrieves an encrypted key, or the like, for descrambling from the received stream using the demultiplex unit 2704, and passes the retrieved key to a condition-release control unit 2706. In general, the CA control 2705 is implemented through a program executed in an LSI or CPU. The condition-release control unit 2706: decrypts the encrypted key and passes the result to a descrambler 2707 corresponding to a descramble circuit. The condition-release control unit 2706 is generally configured by hardware in order to protect confidential information, and prevents the leakage of a key or a method for decrypting a key. Furthermore, in order to prevent a leakage, the passing from the condition-release control unit 2706 to the descrambler 2707 is possible through a hardware link-up of the condition-release control unit 2706 and the descrambler 2707, or by using bus encryption or the like.

The descrambler 2707 descrambles (decrypts) the scrambled stream using the provided key.

The control unit 2702 notifies a TS decoder 2708 of the identifier of audio data and video data within the stream descrambled by the descrambler 2707. The TS decoder 2708 passes the audio data to an audio decoder 2709 and the video data to a video decoder 2711, using the provided identifier of the audio data and video data. The audio decoder 2709 performs analog conversion of digital audio data, and outputs the result through a speaker 2710. The video decoder 2711 performs analogue conversion of digital video data, and outputs the result through a monitor 2712.

### Patent Reference 1: Japanese Unexamined Patent Application Publication No. 2000-295541

### DISCLOSURE OF INVENTION

### Problems that Invention is to Solve

However, with the conventional technique, the CA control unit is implemented as a program executed in the CPU or an LSI. Such program is dependent on the CPU and the LSI and thus, when the conditional access apparatus provided is different, porting becomes necessary. The program making up the CA control unit is developed a CA system firm and, although provided to terminal development firms, since details are confidential, porting is carried out by the CA system firm. As such, in the case where plural terminals are each made up of different CPUs or LSI, there is the problem that much time is required to deploy one CA system for all of them.

Furthermore, with the conventional conditional access apparatus, one receiving terminal can only handle one type of CA system. For example, when a user relocates, there is a need to exchange the terminal itself in the case where the broadcasting company at the relocation site uses a different CA system.

By describing the CA control unit in Java™, the present invention obviates the need for porting a CA control program, and enables development of a CA system over plural terminals in a short time. Furthermore, the present invention has as an object to provide a conditional access apparatus for obviating the need to replace a terminal when a user relocates, by downloading a CA control program described in Java™ corresponding to the CA system of the area to which the user has relocated.

### Means to Solve the Problems

In order to solve the conventional problem, the Java conditional access apparatus is characterized in including: a descramble circuit which descrambles an encrypted broadcast content using corresponding key information, the encrypted broadcast content being included in a broadcast signal; a key generation information obtainment library which obtains key generation information from the broadcast signal according to a specified method, the key generation information being necessary for generating the key information; a condition-release control unit which generates the corresponding key information using the key generation information, and passes the generated corresponding key information to said descrambler; a Java VM which executes a CA control Java program and an other Java program, the CA control Java program: specifying, to said key information obtainment library, a method for obtaining the key generation information stored in the broadcast signal; requesting obtainment of the key generation information; obtaining the key generation information; providing the obtained key generation information to said condition-release control unit; and instructing descrambling by instructing key information; a storage unit in which the CA control Java program is stored, a channel reproduction starting unit which receives, from the Java program, information on a channel to be reproduced, and starts reproduction of the channel which is specified; a registration unit which registers a callback function for enabling the CA control Java program to receive information on the channel to be reproduced; and a notification unit which calls the callback function registered in said registration unit, and notifies said CA control Java program of information on the specified channel to be reproduced, when said channel reproduction starting unit starts reproduction of the channel.

### EFFECTS OF THE INVENTION

According to the present invention, the Java conditional access apparatus includes: a descramble circuit which descrambles an encrypted broadcast content using corresponding key information, the encrypted broadcast content being included in a broadcast signal; a key generation information obtainment library which obtains key generation information from a specific storage area in the broadcast signal, the key generation information being necessary for generating the key information; a Java VM which executes a CA control program which requests, to the key information obtainment library, the obtainment of the key generation information stored in the broadcast signal; a storage unit in which the CA control program is stored; a condition-release control unit which generates the corresponding key information using the extracted key generation information, and passes the generated corresponding key information to the descrambler; and an API which executes a specific process in accordance with a call from a program executed within the apparatus, wherein: the API includes a registration unit which registers a function for enabling the CA control program to receive information on the selected channel to be reproduced; and upon receiving the function for enabling the receiving of the information on the selected channel to be reproduced from the CA control program executed by the Java VM, the registration unit registers the received function; and when the registration unit receives the information on the selected channel to be reproduced, the information on the selected channel to be reproduced is notified to the CA control program executed by the Java VM, by calling the registered function; and upon receiving the notification on the information on the channel to be reproduced, the CA control program executed by the Java VM requests the key generation information obtainment library to obtain key generation information corresponding to the received information on the channel, and passes the received key generation information to the condition-release control unit. Therefore, the CA control program can be written in Java. A program written in Java can operate on all receivers provided with the Java VM, regardless of the type of CPU and LSI, and thus the need for porting the CA control program into each receiver is eliminated.

Furthermore, the Java conditional access apparatus includes a Java a key generation information obtainment library which obtains key generation information from a specific storage area in the broadcast signal, the key generation information being necessary for generating the key information, thereby enabling the CA control program written in Java to extract, from the broadcast signal, key generation information for generating a required key.

Furthermore, in the Java conditional access apparatus, when the registration unit receives the information on the selected channel to be reproduced, the information on the selected channel to be reproduced is notified to the CA control program executed by the Java VM, by calling the registered function. Therefore, the CA control program written in Java can pass, to the condition-release control unit, the key generation information necessary for descrambling, and the video and audio of the channel selected by the user can be properly descrambled.

Furthermore, in the Java conditional access apparatus, the API further includes a registration unit which registers a function for enabling the CA control program to receive information on the selected channel to be reproduced; and upon receiving the function for enabling the receiving of the information on the selected channel to be reproduced from the CA control program executed by the Java VM, the registration unit registers the received function. Therefore, operation is possible even for replacement through importing the CA control program written in Java from an external source.

Furthermore, the Java conditional access apparatus further includes a cancellation unit which cancels the function registered through the reception from the CA control program; and the registration is cancelled when a request for canceling the registration is received from the CA control program executed by the Java VM. Therefore, it is possible to control the notification to the CA control program.

Furthermore, in the Java conditional access apparatus, the API further includes a right checking unit which checks whether or not the CA control Java program has a right to call the API; and the call to the API from the CA control Java program is rejected depending on a judgment of the right checking unit. Therefore, only a specific Java program can control the operation (for example, the registration/cancellation of the function for receiving information on the selected channel to be reproduced) of the CA control program, and thus preventing disarray in the operation of the receiver.

Furthermore, the Java conditional access apparatus further includes a first download unit which receives CA control Java program definition information defining the CA control Java program, obtains the CA control Java program according to the CA control Java program definition information, and stores the obtained CA control Java program in the storage unit, thereby enabling the CA control program written in Java to be replaced by remote operation from the transmitting-side.

Furthermore, the Java conditional access apparatus further includes a second download unit which receives Java program definition information defining a Java program other than the CA control Java program, obtains the Java program according to the Java program definition information, and stores the obtained Java program in the storage unit. Therefore, an existing Java program can be executed. In addition, a receiver that is only capable of executing an existing Java program and a receiver that is also capable of executing a Java program that performs CA control can be used simultaneously in the same broadcasting area.

Furthermore, in the Java conditional access apparatus, when the CA control program definition information is changed, the download unit obtains a new CA control program according to the changed CA control program definition information, and stores the new CA control program in the storage unit, and the Java conditional access apparatus further includes a CA control program control unit which stops the CA control program currently being executed, and activates the new CA control program stored in the storage unit. Therefore, the CA control program written in Java can be replaced by remote operation from the transmitting-side.

Furthermore, in the Java conditional access apparatus, the API further includes a CAS management unit which notifies a user when the CA control program definition information is changed, and thereby the user can be notified that, with a relocation, the CAS is now different, and that a new contract is necessary.

### BRIEF DESCRIPTION OF DRAWINGS

FIG. 1 is a block diagram showing the configuration of a conventional conditional access apparatus.

FIG. 2 is a configuration diagram of the digital television system 100 in the first embodiment according to the present invention.

FIG. 3 is an example of an external view of a digital television, for the digital television 100 according to the present invention.

FIG. 4 is an example of an external view in the case where the input unit 101 is configured of a front panel.

FIG. 5 is a configuration diagram of the structure of a program stored in the digital television 100 according to the present invention.

FIG. 6A is an example of a screen-display of the monitor 113 according to the present invention.

FIG. 6B is an example of a screen-display of the monitor 113 according to the present invention.

FIG. 7 is an example of information stored in the second memory 106 according to the present invention.

FIG. 8A is an example of information stored in the second memory according to the present invention.

FIG. 8B is an example of information stored in the second memory according to the present invention.

FIG. 8C is an example of information stored in the second memory according to the present invention.

FIG. 9 is a schematic diagram showing details contained in the XAIT according to the present invention.

FIG. 10 is a block diagram showing the relationship between the internal configuration of the CA control API 205d and the CA control application, according to the present invention.

FIG. 11 is an example of the interface provided for an object which receives a notification from the CA control API 205.

FIG. 12 is an example of the method prepared by the CA control API 205d.

FIG. 13 is an example of the method prepared by the CA control API 205d.

FIG. 14 is an example of the method prepared by the CA control API 205d.

FIG. 15 is a configuration diagram showing an example of the internal configuration of the CA control application 910.

FIG. 16 is a flowchart showing the operation of the registration unit 901 of the CA control API 205d according to the present invention.

FIG. 17 is a flowchart showing the operation of the cancellation unit 901 of the CA control API 205d according to the present invention.

FIG. 18 is a flowchart showing the operation of the notification unit 903 of the CA control API 205d according to the present invention.

FIG. 19 is a flowchart showing the operation of the accepting unit 904 of the CA control API 205d according to the present invention.

FIG. 20 is a flowchart showing the operation of the CA control application 910 according to the present invention.

FIG. 21 is a flowchart showing the operation of the CA control application 910 according to the present invention.

FIG. 22 is a schematic diagram showing the encryption method according to the present invention.

FIG. 23 is a schematic diagram showing the decryption method according to the present invention.

FIG. 24 is a configuration diagram of the digital television system 2300 in the second embodiment according to the present invention.

FIG. 25 is a configuration diagram of the case of implementing, as an LSI, a part of the digital television system 2300 in the second embodiment according to the present invention.

FIG. 26 is a configuration diagram of the case of implementing, as an LSI, a part of the digital television system 2300 in the second embodiment according to the present invention.

FIG. 27 is a configuration diagram of the digital television 2600 including a CAS management unit 2601 which performs CAS vendor-related management.

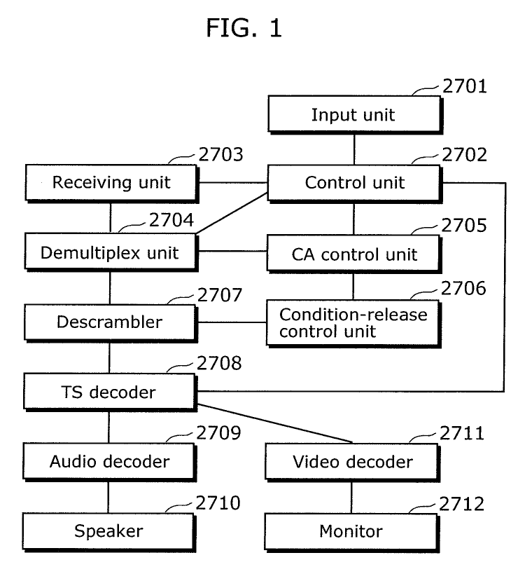

### NUMERICAL REFERENCES

100 Digital television
101 Input unit
102 First memory
103 CPU
104 Receiving unit
105 Demultiplex unit
106 Second memory
107 Condition-release control unit
108 Descrambler
109 TS decoder
110 Audio decoder
111 Speaker
112 Video decoder
113 Monitor

### BEST MODE FOR CARRYING OUT THE INVENTION

### First Embodiment

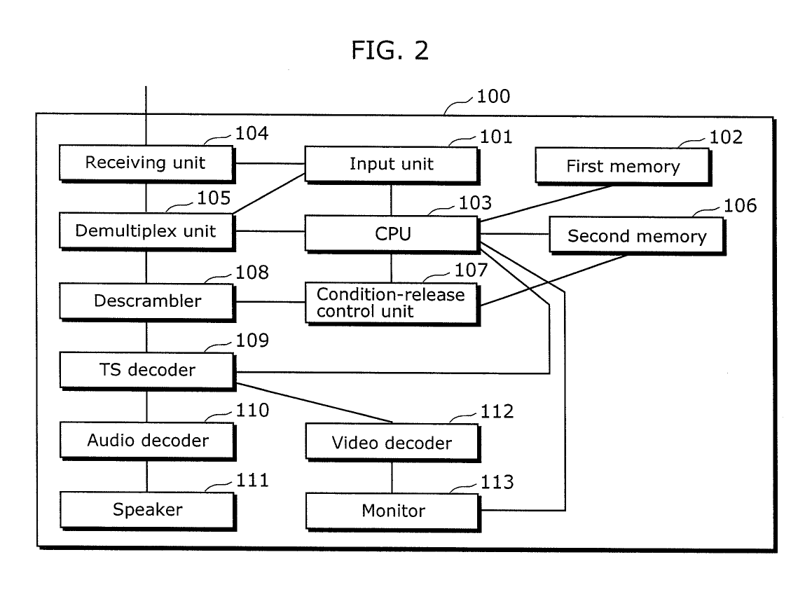

An embodiment of a digital television system including the conditional access apparatus of the present invention shall be described with reference to the drawings. FIG. 2 is a block diagram showing the relationship of constituent elements making up a digital television 100, and includes an input unit 101, a first memory 102, a CPU 103, a receiving unit 104, a demultiplex unit 105, a second memory 106, a condition-release control unit 107, a descrambler 108, a TS decoder 109, an audio decoder 110, a speaker 111, a video decoder 112, and a monitor 113.

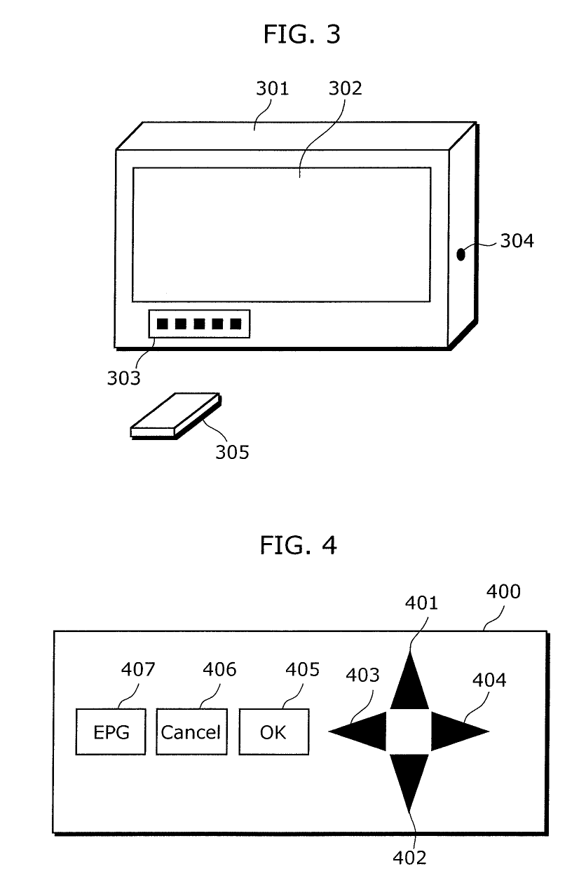

FIG. 3 shows an example of the external appearance of the digital television 100. 301 is a housing corresponding to the digital television 100. 302 corresponds to the monitor 113, and is configured of a Braun tube, a plasma display, liquid crystal display, and the like. 303 is a front panel corresponding to the input unit 101. 304 is an input terminal to which a cable from an antenna or cable television network for connection to the receiving unit 104 is connected. 305 is a remote control. When the digital television 100 accepts an input from the remote control, 303 is a remote control light receiver corresponding to the input unit 101.

The input unit 101 is configured of a front panel, remote control light receiver, and the like, and accepts a channel selection from a user. The input unit 101, in the case where it is a remote control light receiver, accepts the channel selection of the user by accepting the input of the remote control 305 shown in FIG. 3. FIG. 4 shows an example of the input unit 101 in the case where it is configured of a front panel 400 is a front panel, and corresponds to the front panel unit 303 shown in FIG. 3. The front panel 400 includes seven buttons, namely, an up-cursor button 401, a down-cursor button 402, a left-cursor button 403, a right-cursor button 404, an OK button 405, a cancel button 406, and an EPG button 407. When the user presses down a button, the identifier of such pressed button is notified to the CPU 103.

The first memory 102 is configured of a ROM, a flash memory, a hard disk, or the like, and stores a program executed by the CPU 103.

The CPU 103 is a central arithmetic processing apparatus which executes the program stored in the first memory 102.

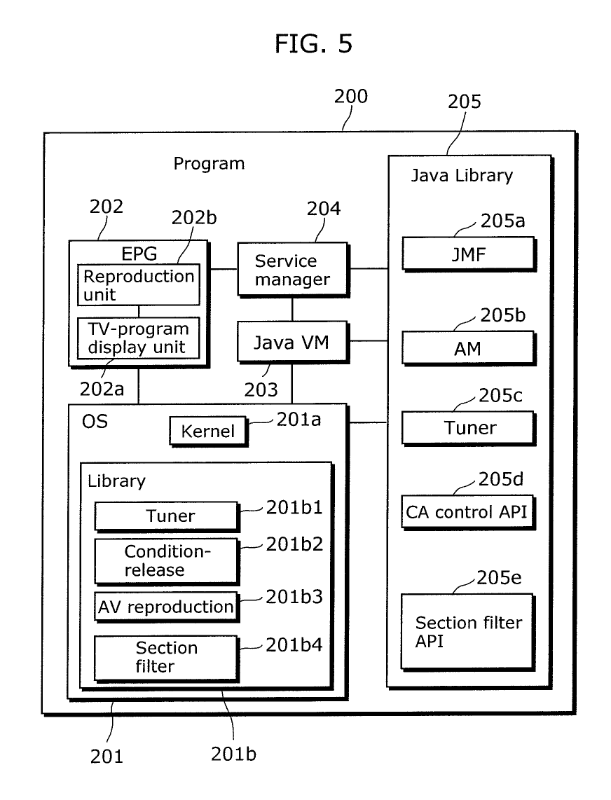

FIG. 5 is a block diagram showing an example of the structure of a program stored in the first memory 102 and executed by the CPU 103. The program 200 is made up of plural subprograms, and is specifically made up of an OS 201 an EPG 202, a Java™ VM 203, a service manager 204, and a Java™ library 205.

The OS 201 is a program activated by the CPU 103 when power to the digital television 100 is turned on. The OS 201 stands for operating system, an example of which is Linux and the like. The OS 201 is a generic name for publicly known technology made up of a kernel 201a for executing a subprogram in parallel with another subprogram and of a library 201b, and therefore a detailed description is omitted. In the present embodiment, the OS 201 and the kernel 201 execute the EPG 202 and the Java™ VM 203 as subprograms. Furthermore, the library 201b provides these subprograms with plural functions required for controlling the constituent elements of the digital television 100.

In the present embodiment, the library includes a tuner 201b1, condition-release 201b2, AV reproduction 202b3, a section filter 202b4, as an example of functions.

The tuner 201b receives tuning information including a frequency from other subprograms and the Tuner 205c of the Java™ library 205, and gives an instruction to the receiving unit 104.

The receiving unit 104 performs tuning based on the provided tuning information, and passes an extracted MPEG transport stream to the demultiplex unit 105. As a result, the other subprograms and the Tuner 205c of the Java™ library 205 can control the receiving unit 104 via the library 201b.

The condition-release 201b receives, from a CA control API 205d, information including an encrypted key needed for decryption, and provides the key to the condition-release control unit 107.

The AV reproduction 201b3 receives the identifier of the audio data and the identifier for the video data from the other subprograms and the Tuner 205c of the Java™ library 205. It then passes the received identifiers of the audio data and video data to the TS decoder 109. [As a result, the TS decoder 109 performs filtering based on the provided identifier, and implements the reproduction of audio/video.

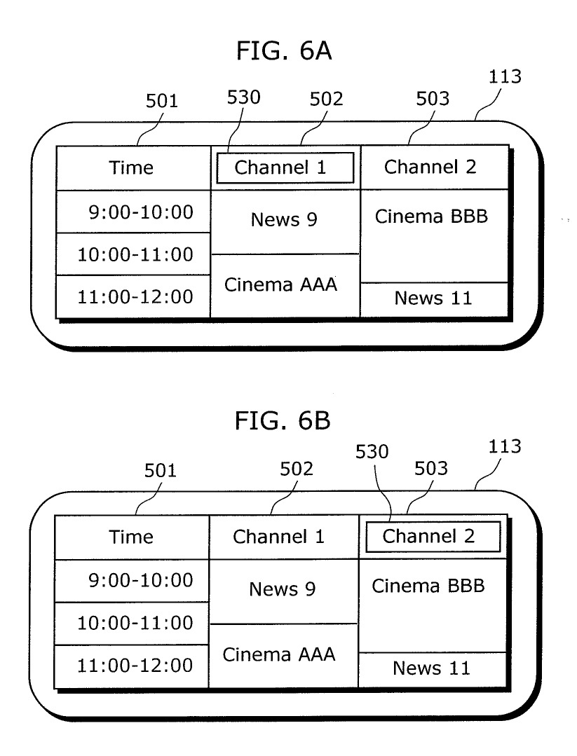

The EPG 202 is made up of a TV-program display unit 202a for displaying a list of TV programs to a user as well as for accepting an input from the user, and a reproduction unit 202b for selecting channels. Here, EPG is an abbreviation of Electric Program Guide. The EPG 202 is activated by the kernel 201a when power to the digital television 100 is turned on. Inside the activated EPG 202, the TV-program display unit 202a and the reproduction unit 202b are activated at the same time. When activated, the TV-program display unit 202a waits for an input from the user via the input unit 101 of the digital television 100. Here, in the case where the input unit 101 is configured of a front panel as shown in FIG. 4, when the user presses down the EPG button 407 of the input unit 101, the identifier of such EPG button is notified to the CPU 103. The TV-program display unit 202a of the EPG 202, which is a subprogram running on the CPU 103, accepts this identifier and displays TV-program information on the monitor 113. FIG. 6A and FIG. 6B are examples of a TV-program listing displayed on the monitor 113. Referring to FIG. 6A, TV-program information is displayed on the monitor 113 in a grid pattern. A column 501 describes time information. A column 502 describes a channel name “Channel 1” and TV-programs to be broadcast during time periods corresponding to the respective times described in the column 501. It is shown that a TV-program “News 9” is broadcast from 9:00 to 10:30, and “Cinema AAA” is broadcast from 10:30 to 12:00 on “Channel 1”. As in the case of the column 502, a column 503 also describes a channel name “Channel 2” and TV-programs to be broadcast during time periods corresponding to the respective times described in the column 501. A TV-program “Cinema BBB” is broadcast from 9:00 to 11:00, and “News 11” is broadcast from 11:00 to 12:00. 530 is a cursor. The cursor 530 moves at the press of the left-cursor 403 or the right-cursor 404 on the front panel 400. When the right-cursor 1104 is pressed down in the state illustrated in FIG. 6A the cursor 530 moves towards the right as shown in FIG. 6B. Meanwhile, when the left-cursor 403 is pressed down in the state illustrated in FIG. 6B, the cursor 530 moves towards the left as shown in FIG. 6A. When the OK button 405 on the front panel 400 is pressed down in the state shown in FIG. 6A, the TV-program display unit 202a notifies the reproduction unit 202b of the identifier of “Channel 1”. When the OK button 405 on the front panel 400 is pressed down in the state shown in FIG. 6B, the TV-program display unit 202a notifies the reproduction unit 202b of the identifier of “Channel 2”.

Furthermore, the program display unit 202a stores, in advance, TV-program information to be displayed, in the second memory 106. Generally, TV-program information is piggybacked onto a broadcast signal. Obtaining TV-program information and storing this in the second memory 106 takes time. However, it becomes possible to quickly display a TV-program table by displaying the TV-program information that is pre-stored in the second memory 106 at the press of the EPG button 407 of the input unit 101.

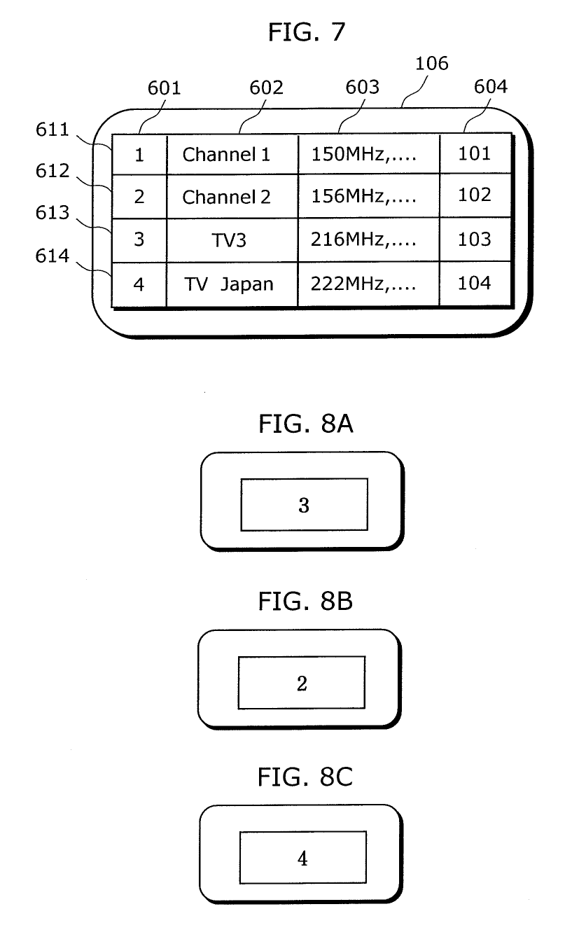

The reproduction unit 202b reproduces the channel using the received identifier of the channel, that is, it reproduces the video and audio making up the channel. The relationship between channel identifiers and channels is pre-stored in the second memory 106 as channel information. FIG. 7 shows an example of the channel information stored in the second memory 106. The channel information is stored in tabular form. A column 601 describes the identifiers of channels. A column 602 describes channel names. A column 603 describes tuning information. Here, the tuning information is represented by values to be provided to the receiving unit 104, such as frequency, transmission rate, and coding ratio. A column 604 describes program numbers. Program numbers are numbers used to identify PMTs defined by the MPEG-2 Standard. A description about PMT is given later. Each of rows 611 to 614 indicates a set of the identifier, channel name, and tuning information of each channel. The row 611 describes a set that includes “1” as an identifier, “Channel 1” as a channel name, a frequency of “150 MHz” as tuning information, and “101” as a program number. The reproduction unit 202b passes the identifier of the received channel directly to the service manager in order to reproduce the channel.

Moreover, when the user presses down the up-cursor 401 and the down-cursor 402 on the front panel 400 while the reproduction is taking place, the reproduction unit 202b receives a notification about such pressing from the input unit 101 via the CPU 103, and switches the channel being reproduced accordingly. When the up-cursor 401 is pressed down, a channel having the next lower channel identifier to that of the currently-reproduced channel is reproduced, and when the down-cursor 402 is pressed down, a channel having the next higher channel identifier to that of the currently-reproduced channel is reproduced. First, the reproduction unit 202b stores, in the second memory 106, the identifier of the channel that is currently being reproduced. FIGS. 8A, 8B and 8C show example identifiers of channels stored in the second memory. FIG. 8A shows that an identifier “3” is stored, and by referring to FIG. 7, it is shown that a channel having the channel name “TV 3” is currently being reproduced. When the user presses down the up-cursor 401 in the state illustrated in FIG. 8A, the reproduction unit 202b refers to the channel information shown in FIG. 7, and passes the identifier “2” of a channel having the channel name of “Channel 2” to the service manager in order to switch reproduction to the channel having the channel name of “Channel 2” which is the next lower channel from the currently-reproduced channel. At the same time, the reproduction unit 202b rewrites the identifier stored in the second memory 106 to the channel identifier “2”. FIG. 8B shows the state in which the channel identifier has been rewritten. Furthermore, when the user presses down the down-cursor 401 in a state illustrated in FIG. 8A, the reproduction unit 202b refers to the channel information shown in FIG. 7, and passes the identifier “4” of a channel having the channel name of “TV Japan” to the service manager in order to switch reproduction to the channel having the channel name of “TV Japan” which is the next higher channel to the currently-reproduced channel. At the same time, the reproduction unit 202b rewrites the identifier stored in the second memory 106 to the channel identifier “4”. FIG. 8C shows the state in which the channel identifier has been rewritten. The channel identifier is saved even when power to the digital television 100 is cut-off since it is stored in the second memory 106.

In addition, upon being activated when power to the digital television 100 is turned on, the reproduction unit 202b reads the channel identifier stored in the second memory 106. Then, the reproduction unit 202b passes such channel identifier to the service manager. Thus, when power is turned on, the digital television 100 is able to start the reproduction of the last channel that was reproduced during its previous operation.

The Java™ VM 203 is a Java™ virtual machine that sequentially analyzes and executes programs written in the Java™ language. Programs written in the Java™ language are compiled into intermediate codes known as a byte code which are not dependent on hardware. The Java™ virtual machine is an interpreter that executes such byte code. Some Java™ virtual machines translate the byte code into an execution format which can be interpreted by the CPU 103 before passing it to the CPU 103 which executes it. The Java™ VM 203 gets activated, with a Java™ program to be executed being specified by the kernel 201a. In the present embodiment, the kernel 201a specifies the service manager 204 as a Java™ program to be executed. Details of the Java™ language are described in many publications such as “Java™ Language Specification” (ISBN 0-201-63451-1). Here, such details are omitted. Furthermore, the detailed operation of the Java™ VM itself is described in many publications such as “Java™ Virtual Machine Specification” (ISBN 0-201-63451-X). Here, such details are omitted.

The service manager 204, which is a Java™ program written in the Java™ language, is sequentially executed by the Java™ VM 203. It is possible for the service manager 204 to call and to be called by another subprogram not written in the Java™ language, through the INI (Java™ Native Interface). The INI is also described in many publications such as in the book “Java™ Native Interface” and so on. Here, such details are omitted.

The service manager 204 accepts the identifier of the channel from the reproduction unit 202b, through the JNI. The service manager 204 first passes the identifier of the channel to the Tuner 205c in the library 205, and requests for tuning. The Tuner 205c refers to the channel information stored in the second memory 106, and obtains the tuning information. Now, when the service manager 204 passes the identifier “2” of the channel to the Tuner 205c, the Tuner 205c refers to the column 612 shown in FIG. 7, and obtains the corresponding tuning information “156 MHz”. The Tuner 205c passes the tuning information to the receiving unit 104 via tuner 201b1 of the library 201b of the OS 201. The receiving unit 104 performs tuning according to the given tuning information.

The service manager 204 requests the CA control API 205d inside the Java™ library 205 to perform descrambling. The CA control API 205d requests the descrambling to a CA control application stored in the second memory, to be described later. The CA control application passes information including an encrypted key to the CA control API 205d, after a required processing is performed. The CA control API 205d provides, to the condition-release control unit 107, the information including the encrypted key which it receives through the condition-release 201b2 of the library 201b of the OS 201.

The service manager 204 provides the identifier of the channel to a JMF 205a inside the Java™ library 205, and requests for the reproduction of the video and audio.

First, the JMF 205a obtains, from a PAT and a PMT, identifiers for identifying the video and audio to be reproduced. PAT and PMT are tables, defined by the MPEG-2 standard, that show the TV-program line-up included in an MPEG-2 transport stream. The PAT and PMT are extracted from the MPEG-2 transport stream using the demultiplex unit 105. The extraction method is publicly known technology and thus description shall be omitted.

Next, the IMF 205a passes the obtained identifiers of the audio data and video data to the AV reproduction 201b3 of the library 201b of the OS 201. The AV reproduction 201b3 then passes the received identifiers of the audio data and video data to the TS decoder 109. The TS decoder 109 performs filtering based on the provided identifiers of the audio data and video data, and passes the audio data to the audio decoder 110 and the video data to the video decoder 112.

Finally, the service manager 204 provides the channel identifier to an AM 205b in the Java™ library 205, and requests for data broadcast reproduction. Here, data broadcast reproduction refers to extracting a Java™ program included in the MPEG-2 transport stream, and having it executed by the Java™ VM 1203. As a technique for embedding a Java™ program into an MPEG-2 transport stream, a method known as DSMCC, which is described in the MPEG specification ISO/IEC13818-6, is used. Here, detailed description of DSMCC shall be omitted. The DSMCC format defines a method of encoding a file system, which is made up of directories and files used by a computer, in packets within an MPEG-2 transport stream. Furthermore, information about the Java™ program to be executed is embedded and sent in packets in the MPEG-2 transport stream in a form referred to as AIT. AIT is an abbreviation of Application Information Table defined in the 10th chapter of the DVB-MHP Standard (formally as, ETS TS 101 812 DVB-MHP Specification V1.0.2).

The AM 205b downloads a Java™ program based on the information described in the AIT, and stores this in the second memory 106. The method for obtaining the AIT, downloading the Java™ program, and storing into the second memory is publicly known technology, and thus description shall be omitted.

Next, the AM 205b passes to the Java™ VM 203, the Java™ program downloaded to the second memory 106. The Java™ VM 203 executes the Java™ program passed to it. Upon receiving an identifier of an other channel, the service manager stops the execution, though the respective libraries included in the Java™ library 205, of the currently-reproduced video/audio and Java™ program, likewise through the respective libraries included in the Java™ library 205, and performs the execution of video/audio and a Java™ program based on the newly received channel identifier.

Furthermore, the service manager 204 also includes a function for receiving the identifier of a channel from a Java™ program executed on the Java™ VM 203, aside from the reproduction unit 202b. Specifically, a Java™ language class as and the method for obtaining the identifier of the channel are provided. Upon receiving an identifier of a channel, the service manager stops the execution, though the respective libraries included in the Java™ library 205, of the currently-reproduced video/audio and Java™ program, likewise through the respective libraries included in the Java™ library 205, and subsequently performs the execution of a new video/audio and Java™ program based on the newly received channel identifier.

In addition, the service manager 204 also performs the downloading/storing and execution of the Java™ program.

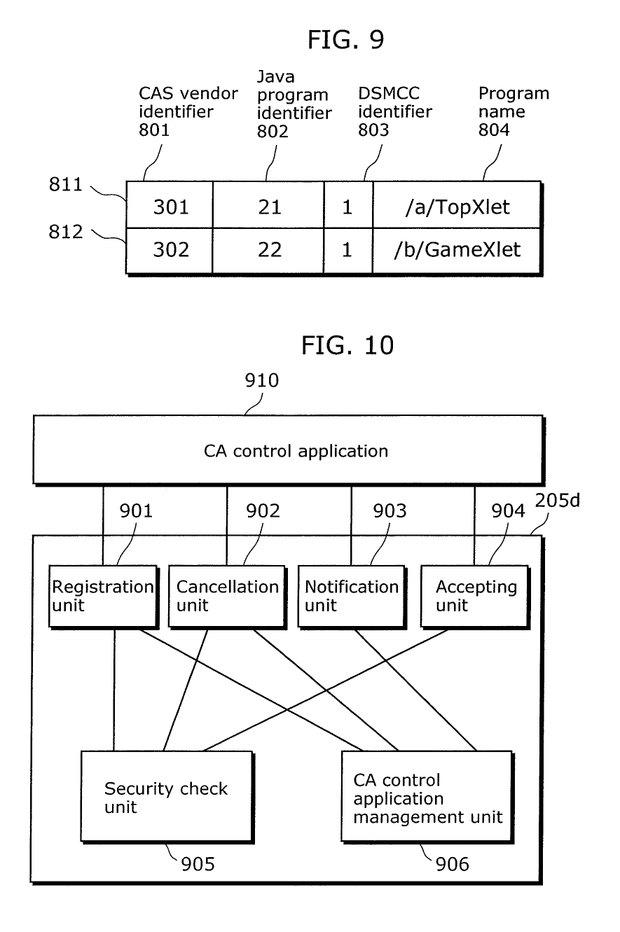

The service manager obtains an XCAIT to be newly defined in the present invention, and downloads and executes the CA control application. XCAIT defines a CA control application and stores approximately the same information as the AIT defined in the 10th chapter of the DVB-MHP Standard (formally as, ETS TS 101 812 DVB-MHP Specification V1.0.2). As with the AIT, the XCAIT defines a Java™ program executed by the Java™ VM 203. The difference is, as the Java™ program defined, the AIT defines an arbitrary Java™ program, whereas the Java™ program defined by the XCAIT is a CA control application. FIG. 9 is a chart schematically showing an example of the XCAIT. A column 801 describes identifiers of the CAS vendor that developed the CA control application. Here, CAS is an abbreviation for Conditional Access System. A column 802 describes identifiers of Java™ programs. Column 803 describes DSMCC identifiers for extracting packet IDs within an MPEG transport stream including a CA control application in the DSMCC format. A column 804 describes the program name of CA control applications. Rows 811 and 812 describe a set of information on the CA control application. The CA application described in row 811 is the set of the CAS vendor identifier “301”, a Java™ program identifier “21”, a DSMCC identifier “1”, and a program name “a/TopXlet”. The CA application described in row 812 is the set of the CAS vendor identifier “302”, a Java™ program identifier “22”, a DSMCC identifier “1”, and a program name “b/GameXlet”. Here, the two CA control applications have the same DSMCC identifier which indicates that the two CA control applications are included within a single file system encoded in the DSMCC format. Here, although only 4 items of information are defined for the CA control application, more information may actually be defined, as in the AIT.

The method for downloading a Java™ program defined by the XCAIT is the same as that in the case of using the AIT. The CA control application is encoded using DSMCC and piggybacked onto the MPEG transport stream. The service manager 204 extracts the CA control application piggybacked onto the MPEG transport stream, and stores it in the second memory 106. Note that even when other methods are used for the transmission method for the CA control application, the present invention can still be implemented. For example, the use of TCP/IP and the like via the Internet is possible. Alternatively, implementation is also possible even when the CA control application is built-into the second memory in advance, instead of being downloaded. Alternatively, implementation is also possible by obtainment from a detachable storage device such as an SD memory card and the like.

After downloading, the service manager 204 requests the activation of the CA control application to the AM 205b of the Java™ class library.

The Java™ library 205 is a collection of plural Java™ libraries stored in the first memory 102. In the present embodiment, the Java™ library 205 includes the JMF 205a, the AM 205b, the Tuner 205c, the CA control API 205d, a section filter API 205e, and so on. Aside from the CA control API 205d, all are defined in the DVB-MHP Standard (formally as, ETS TS 101 812 DVB-MHP Specification V1.0.2).

Since the functions of the JMF 205a, AM 205b, and Tuner 205c are already described, further description shall be omitted.

The CA control API 205d performs the role of an interface between the CA control application and the digital television 100. FIG. 10 is a block diagram showing the relationship between the internal configuration of the CA control API 205d and the CA control application. The CA control API 205d includes a registration unit 901, a cancellation unit 902, a notification unit 903, an accepting unit 904, a security check unit 905, and a CA control application management unit 906. 901 is a CA control application downloaded by the service manager 204 and stored in the second memory 106.

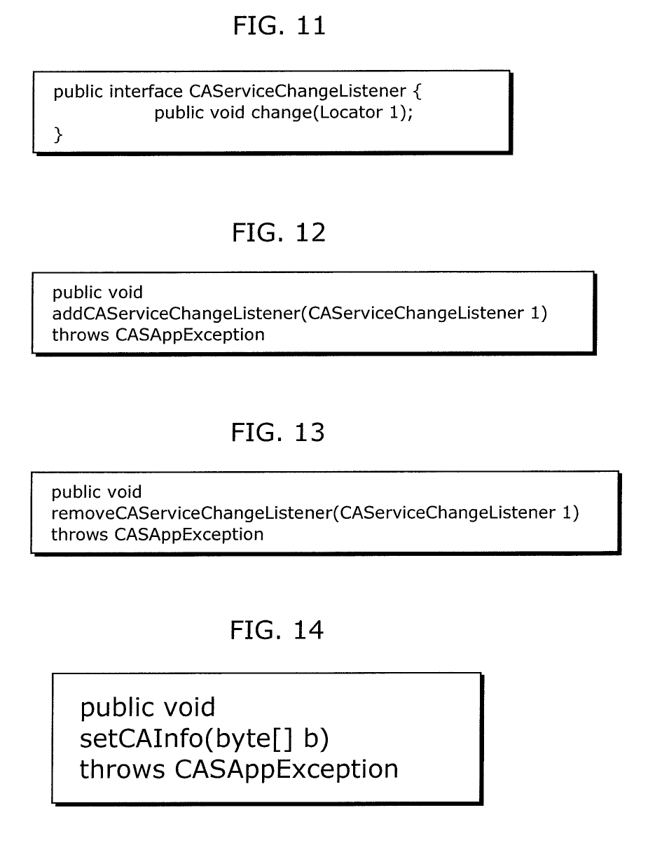

The registration unit 901 accepts, from the CA control application 910, a callback function for receiving a channel selection notification. FIG. 11 shows an example of an interface CAServiceChangeListener which defines a callback function. Since the CA control application 910 is a Java™ program, one of the objects making up the program is provided with this interface. The provision of the interface is the description method of the Java™ program defined in the Java™ language. The object provided with this interface must provide a method change within the program. FIG. 12 shows a Java™ method representing an example of the registration unit 901. The method addCAServiceChangeListener in FIG. 12 accepts the object provided with the CAServiceChangeListener interface from the application. Moreover, the method addCAServerChangeListener inquires to the security check unit 905 whether the Java™ program which called such method holds the right to call such program and, when the right is not held, rejects acceptance and throws a CASAppException. The accepted object provided with the CAServiceChangeListener is registered in the CA control application management unit 906.

The cancellation unit 902 accepts, from the CA control application 910, a callback function for receiving a channel selection notification. FIG. 13 shows a Java™ method representing an example of the cancellation unit 902. The method removeCAServiceChangeListener in FIG. 13 accepts, from the application, the cancellation of the object provided with the CAServiceChangeListener interface registered in the registration unit 910. Moreover, the method removeCAServerChangeListener inquires to the security check unit 905 whether the Java™ program which called such method holds the right to call such program and, when the right is not held, rejects acceptance and throws a CASAppException. The object provided with the CAServiceChangeListener is cancelled from the CA control application management unit 906.

The notification unit 903 passes information of the channel to be descrambled to the CA control application 910 when changing the channel to be reproduced by the service manger 204. To be more specific, the notification calls the change method of the object managed by the CA control application management unit 906, and passes a Locator object representing a channel in the argument thereof. The Locator is defined in the DVB-MHP Standard (formally as, ETS TS 101 812 DVB-MHP Specification V1.0.2).

The accepting unit 904 receives, from the CA control application 910, information including an encrypted key for descrambling audio data and video data within the descrambled MPEG transport stream, and passes it to the condition-release control unit 107 via the condition-release 201b2. FIG. 14 shows a Java™ method representing an example of the accepting unit 904. A method setCAInfo in FIG. 14 receives binary data (in other words, encrypted key information) from the CA control application 910. Moreover, the method setCAInfo inquires to the security check unit 905 whether the Java™ program which called such method holds the right to call such program and, when the right is not held, rejects acceptance and throws a CASAppException.

The security check unit 905 checks whether the a Java™ application holds a right to call the CA control API 205d. This is to prevent an unspecified Java™ program from calling the CA control API 205d and putting the system in disarray, or the unauthorized use of the system. By having only a specific CA control application 910 calling the CA control API 205d, the descrambling of a stream in accordance with a specific CA system can be implemented. The method for checking uses the Java™ Security framework defined by Java™. It is also possible to permit only a CA control application having the MonitorAppPermission defined in the cable television Standard OCAP specification defined by CableLabs® in particular. However, other methods may also be used.

The CA control application management unit 906 holds the object registered by the CA control application 910 through the registration unit 901. When the same object is registered, it is possible to hold only one, and it is also possible to hold two. Either can be implemented.

The section filter API 205e provides a function for retrieving MPEG section data from an MPEG transport stream. When MPEG section obtainment is requested by an application, the section filter API 205e obtains the MPEG section data through a section filter 201b4. Details are defined in the DVB-MHP Standard (formally as, ETS TS 101 812 DVB-MHP Specification V1.0.2) and thus description shall be omitted.

The receiving unit 104, which is connected is connected to a cable from an antenna or a cable television station, receives a broadcast signal, tunes to the frequency specified by the CPU 103, extracts an MPEG transport stream, and passes it to the demultiplex unit 105.

The demultiplex unit 105 receives the MPEG transport stream from the receiving unit 104, extracts information specified by the CPU 103 and passes it to the CPU 103. Furthermore, the demultiplex unit 105 passes the MPEG transport stream, as is, to the descrambler 108.

The second memory is configured of a device that can hold information even when power is turned off, such as a flash memory, a hard disk, or the like, and stores a program executed by the CPU 103 by downloading the program using the demultiplex unit 105. Alternatively, a detachable storage device such as an SD memory card and the like may also be used.

The condition-release unit 107 decrypts the encrypted key extracted by the program being executed on the CPU 103 using the demultiplex unit 105, and generates the original key and passes the original key to the descrambler 108. The method for generating the original key may refer to a digital television-specific key stored in the second memory 106, or may use a key that identifies a user from a BCAS card that is used within Japan. For the internal configuration of the condition-release control unit 107, LSI developed by the CA system vendor that developed the CA system is widely used, as is, and such internal configuration is dependent on the CA system vendor. The present invention can be implemented without dependency on the configuration of the condition-release control unit 107 which was prepared by the CA system vendor. Note that it is also possible to implement a configuration in which the internal software of the condition-release control unit 107 is downloaded. For example, a Java™ Card LSI can be used for the condition-release control unit 107. In this case, as a CA control API 205, it is possible to implement the use of an API defined by the JSR 177 defined by the JCP (Java™ Community Process.

During the passing of the original 107 to the descrambler 108, it is possible to use bus encryption between the condition-release control unit 107 and the descrambler 108 key from the condition-release control unit to conceal the original key. Since there are many publicly known methods for implementing the bus encryption and these are not the essence of the present invention, detailed description shall be omitted.

The descrambler 108 descrambles (decrypts) the scrambled MPEG transport stream provided by the demultiplex unit 105, using the key provided by the condition-release control unit 107, and passes the result to the TS decoder 109.

The TS decoder 109 receives the identifiers of the audio data and video data from the AV reproduction 201b3. In addition, the TS decoder 109 passes audio data and video data corresponding to the received identifiers of the audio data and video data, from the descrambled stream received from the descrambler 108, to the audio decoder 110 and the video decoder 112, respectively.

The audio decoder 110 performs analog conversion of digital audio data, and passes the result to the speaker 111.

The speaker 111 outputs the received analog sound.

The video decoder 112 performs analog conversion of digital video data, and passes the result to the monitor 113.

The monitor 113 is configured of a Braun tube, a plasma display, liquid crystal display, and the like, and outputs the received analogue image.

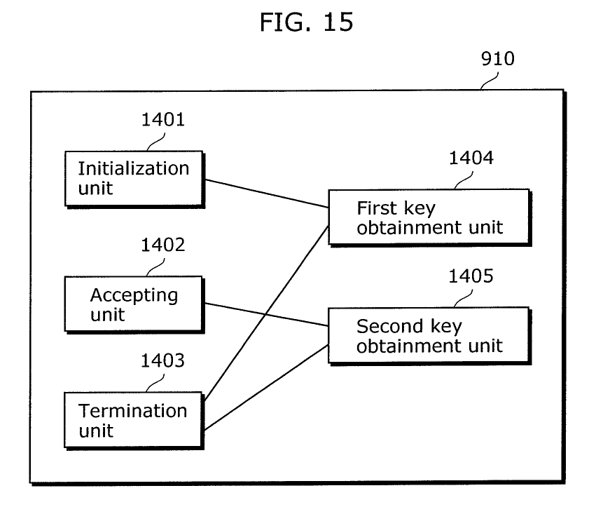

The CA control application downloaded by the digital television 100 shall be described. FIG. 15 is a block diagram showing an example of the configuration of the CA control application. The CA control application 910 includes an initialization unit 1401, an accepting unit 1402, a termination unit 1403, a first key obtainment unit 1404, and a second key unit 1405.

The CA control application 910 is provided with an Xlet interface, as in an application defined in the DVB-MHP Standard (formally as, ETS TS 101 812 DVB-MHP Specification V1.0.2). The service manager 204 requests the activation of the CA control application 910 to the AM 205b, at the time when the digital television 100 is activated and when the CA control application 910 is downloaded. The AM 205b calls the initialization method (iniXlet) and the starting method (startxlet) of the Xlet interface provided in the CA control application 910. In the CA control application 910, when either of the methods is called, the initialization unit 1401 registers the callback function in the registration unit 901 of the CA control API 205d. To be more specific, the object provided with the interface shown in FIG. 11 is registered using the method shown in FIG. 12.

When the object registered in the registration unit 901 of the CA control API 205d receives a channel change notification from the notification unit 903 of the CA control API 205d, the accepting unit 1402 notifies the first key obtainment unit and the second key obtainment unit or one of both.

When the CA control application 910 ends descrambling, the termination unit 1403 calls the cancellation unit 902 of the CA control API 205d, and cancels the registered object. The end of the descrambling is called when a new CA control application is downloaded, and an operating CA control application is cancelled. To be more specific, it is when the terminate method (destroyXlet) of the interface is called by the AM 205b.

The first key obtainment unit 1404 retrieves a first encrypted key piggybacked onto the MPEG transport stream, by calling the section filter API 205e, and so on. Where the key is embedded within the MPEG transport stream depends on the installation of the CAS vendor. For example, it may be embedded as unique data in a first descriptor loop of the PMT, and may also be embedded, using a unique format, within MPEG section data having a specific packet ID. Furthermore, it is also possible to use a network and obtain the first encrypted key, and so on. At this time, the CA control application 910 may hold, within a program, the information regarding where the first encrypted key embedded through the above-mentioned methods is embedded. The CA control application 910 may retrieve the information regarding where the first encrypted key is embedded from a broadcast signal, and may retrieve the information using a network. In other words, it is possible that, prior to calling the section filter API 205e, the CA control application 910 holds the information regarding where to retrieve the first key, and requests the corresponding key generation library (in this example, the section filter API 205e) to obtain the encrypted first key based on the held information, and the corresponding key generation library (in this example, the section filter API 205e) obtains the encrypted first key based on the held information. The retrieved encrypted key is passed to the condition-release control unit 107 via the accepting unit 904 of the CA control API 205d. Since the key is periodically or non-periodically updated, upon every update, it is passed to the condition-release control unit 107 via the accepting unit 904 of the CA control API 205d.

The first key obtainment unit 1405 also retrieves a second encrypted key piggybacked onto the MPEG transport stream, by calling the section filter API 205e, and so on. Where the key is embedded within the MPEG transport stream depends on the installation of the CAS vendor. For example, it may be embedded, using a unique format, within MPEG section data having a specific packet ID. Furthermore, it is also possible to use a network and obtain the first encrypted key. At this time, the CA control application 910 may hold, within a program, the information regarding where the second encrypted key embedded through the above-mentioned methods is embedded. The CA control application 910 may retrieve the information regarding where the second encrypted key is embedded from a broadcast signal, and may retrieve the information using a network. In other words, it is possible that, prior to calling the section filter API 205e, the CA control application 910 holds the information regarding where to retrieve the second key, and requests the corresponding key generation library (in this example, the section filter API 205e) to obtain the encrypted second key based on the held information, and the corresponding key generation library (in this example, the section filter API 205e) obtains the encrypted second key based on the held information. The retrieved encrypted key is passed to the condition-release control unit 107 via the accepting unit 904 of the CA control API 205d. Since the key is periodically or non-periodically updated, upon every update, it is passed to the condition-release control unit 107 via the accepting unit 904 of the CA control API 205d.

Here, although two keys are used in the present embodiment, implementation is possible even with one key or 3 or more keys.

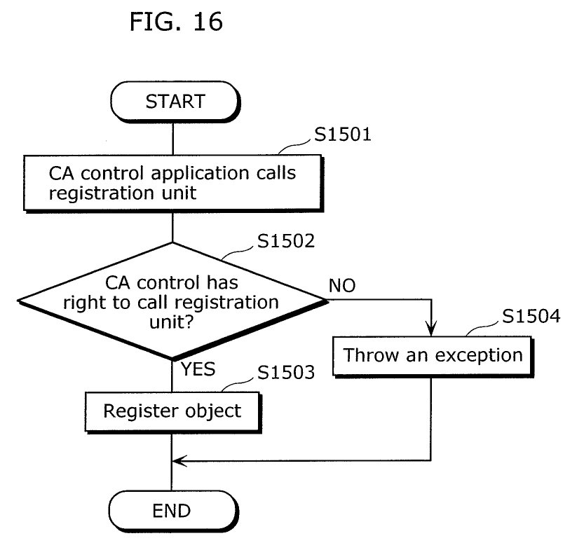

FIG. 16 is a flowchart showing the operation of the registration unit 901 of the CA control API 205d. The CA control application 910 calls the registration unit 901 of the CA control API 205d (step S1501). The registration unit 901 inquires to the security check unit 905 whether the CA control application 910 holds the right to call the registration unit 901 (step S1502). When held, the registration unit 901 registers an object for receiving a channel change notification, in the CA control application management unit 906 (step S1503). When not held, the registration unit 901 rejects the registration, and throws an exception (step S1504).

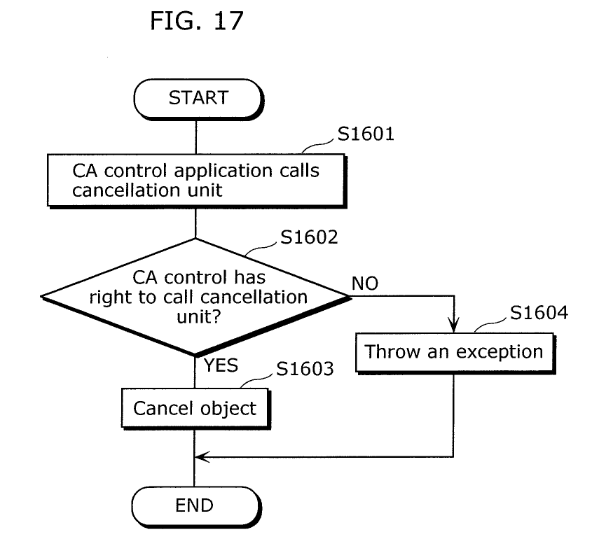

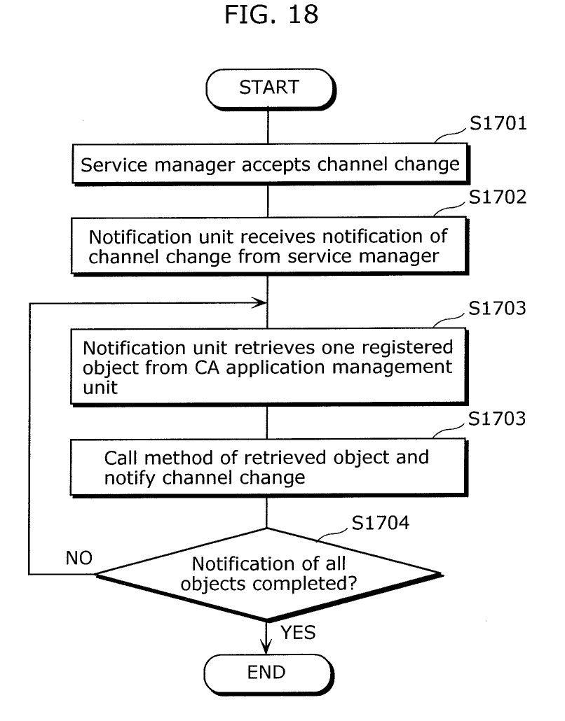

FIG. 17 is a flowchart showing the operation of the cancellation unit 902 of the CA control API 205d. The CA control application 910 calls the cancellation unit 902 of the CA control API 205d (step S1601). The cancellation unit 902 inquires to the security check unit 905 whether the CA control application 910 holds the right to call the cancellation unit 902 (step S1602). When held, cancellation unit 902 cancels the object for receiving a channel change notification, from the CA control application management unit 906 (step S1603). When not held, cancellation unit 902 rejects the cancellation, and throws an exception (step S1604). Note that in the case where the object, which is for receiving the channel change notification, that is to be cancelled is not to be stored in the CA control management unit 906, it is possible to proceed to the next process without performing the cancellation.

FIG. 18 is a flowchart showing the operation of the notification unit 903 of the CA control API 205d. The service manager 204 accepts a channel change from the user or a Java™ program (step S1701). The service manager 204 notifies the channel change to the notification unit 903 (step S1702). The notification unit 903 retrieves on object registered in the CA application management unit 906 (step S1703). The notification unit 903 calls the method of the retrieved object, and notifies the channel change (step S1704). At this time, the notification unit 903 passes information on the changed channel. The notification unit 903 checks whether or not other objects for which channel change is not notified are present in the CA application management unit 906 (step S1705) and, when present, control is moved to step S1703. When all objects are notified, the process ends.

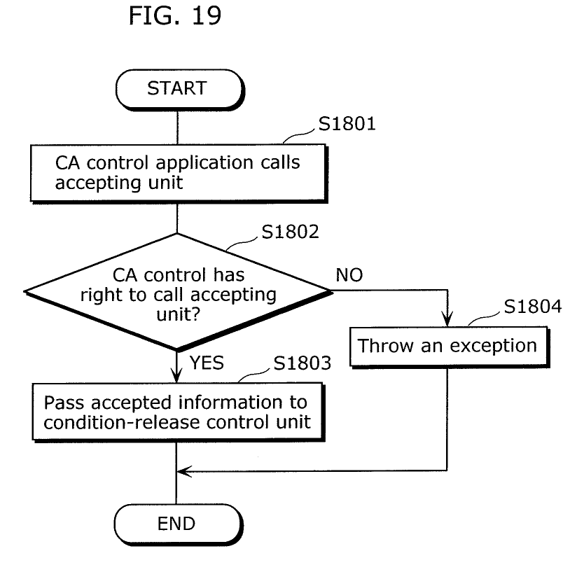

FIG. 19 is a flowchart showing the operation of the receiving unit 904 of the CA control API 205d. The CA control application 910 calls the receiving unit 904 of the CA control API 205d (step S1801). The receiving unit 904 inquires to the security check unit 905 whether the CA control application 910 holds the right to call the receiving unit 904 (step S1802). When held, the receiving unit 904 passes the data accepted from the CA control application 910 to the condition-release control unit (step S1803). When not held, the receiving unit 904 rejects the cancellation, and throws an exception (step S1804).

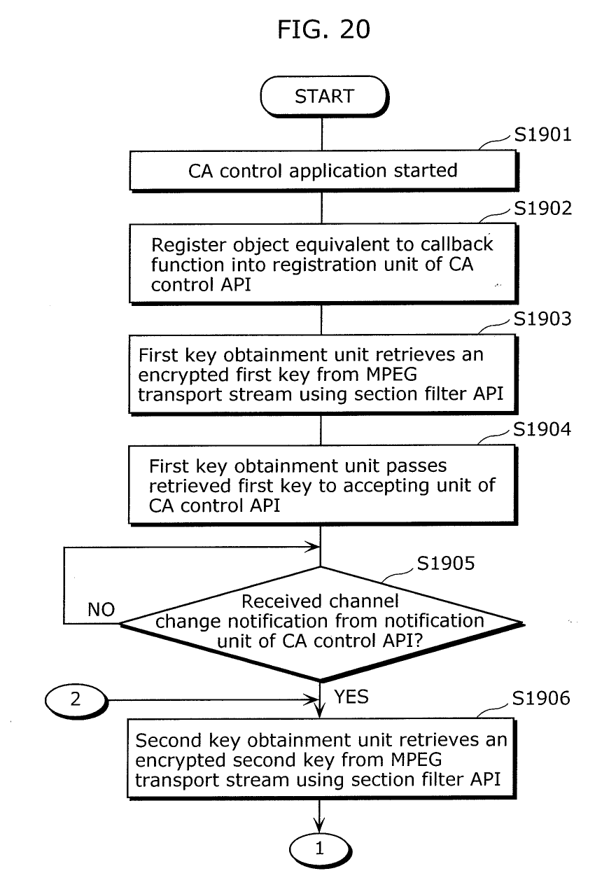

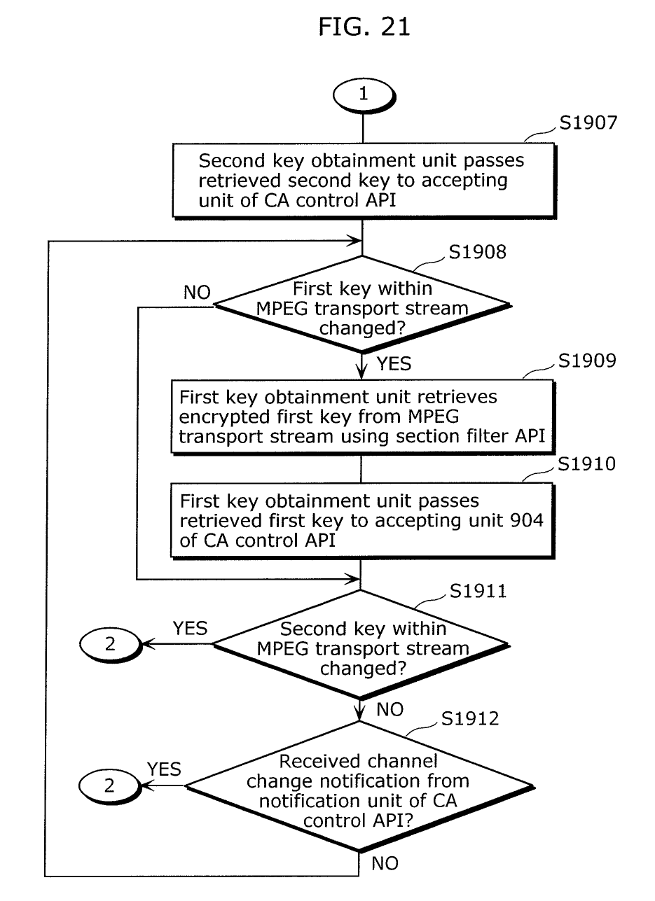

FIG. 20 and FIG. 21 are flowcharts showing an example of the operation from the activation of the CA control application 910. The CA control application 910 is activated by the service manager 204 (step S1901). The CA control application 910 registers an object equivalent to the callback function in the registration unit 901 of the CA control API 205d (step S1902). The first key obtainment unit 1404 retrieves an encrypted first key from the MPEG transport stream using the section filter API 205e (step S1903). The first key obtainment unit 1404 passes the retrieved first key to the accepting unit 904 of the CA control API 205d (step S1904). Upon receiving a channel change notification from the notification unit 903 of the CA control API 205d (step S1905), in the CA control application 910, the second key obtainment unit 1405 retrieves an encrypted second key from the MPEG transport stream using the section filter API 205e (step S1906). The second key obtainment unit 1405 passes the retrieved second key to the accepting unit 904 of the CA control API 205d (step S1907). When a first key within the MPEG transport stream is changed (step S1908), the first key obtainment unit 1404 retrieves the encrypted first key from the MPEG transport stream using the section filter API 205e (step S1909), and the first key obtainment unit 1404 passes the retrieved first key to the accepting unit 904 of the CA control API 205d. When a second key within the MPEG transport stream is changed (step S1911), the second key is retrieved anew by moving the control to step S1906. Upon receiving a channel change notification from the notification unit 903 of the CA control API 205d (step S1912), the second key is retrieved anew by moving the control to step S1906.

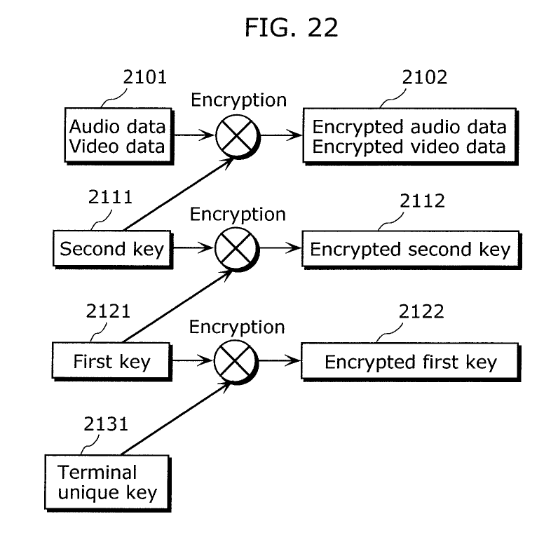

This operation is a premise of the encryption method shown in FIG. 22, and in the case where an other method is used, the operation of the CA control application 910 changes. With reference to FIG. 22, 2101 describes audio data and video data to be transmitted. These data are encrypted using a second key 2111 and encrypted audio data and encrypted video data 2102 are generated, and these are transmitted. The second key 2111, also called a time-varying key, is changed within a short period of time (for example 2 seconds). The second key 2111 is encrypted using a first key 2121 and an encrypted second key 2111 is generated, and this is transmitted. The first key 2121 is changed in long time intervals. The first key 2121 is encrypted using a unique key 2131 of the terminal owned by a contracting party and an encrypted first key 2122 is generated, and this is transmitted.

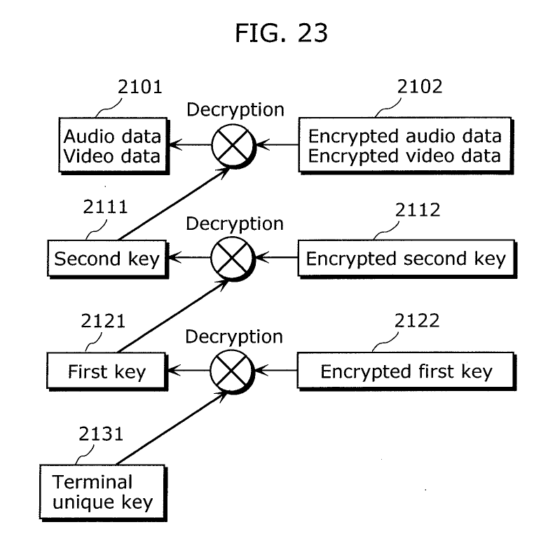

FIG. 23 shows a decryption method corresponding to the encryption method shown in FIG. 22. The transmitted encrypted first key 2122 is decrypted using the unique key 2131 held by the terminal, and the first key 2121 is generated. Using the first key 2121, the received encrypted second key 2122 is decrypted, and the second key 2121 is generated. The conditional access control unit 107 receives the encrypted first key 2122 and the encrypted second key 2112, and generates the second key 2121. Using the generated second key 2121, the descrambler 108 decrypts the encrypted audio data and encrypted video data 2102, and the original audio data and video data 2101 are generated.

Note that in the present embodiment, for the name of the interface and method shown to illustrate the CA control API 205d, an arbitrary name may be used as long as it is a name that satisfies the Java™ language specification.

Furthermore, in the present embodiment, although the digital television 100 recognizes the presence of the CA control application using XCAIT, then downloads the CA control application, it is also possible to define the CA control application in the AIT defined by the DVB-MHP standard. By adding, in the AIT, information indicating a CA control application as a Java™ program, it is possible to permit the calling of the CA control API 205d only to the CA control application. However, the CA control application does not operate in an existing DVB-MHP-compliant receiver that is not provided with the CA control API 205d. As such, in an environment where an existing DVB-MHP-compliant receiver that is not provided with the CA control API 205d and a new receiver including the CA control API 205d mutually exist, the operation of the existing receiver can be guaranteed by using XCAIT. Since the existing receiver does not recognize XCAIT, the CA control application cannot be downloaded.

### Second Embodiment

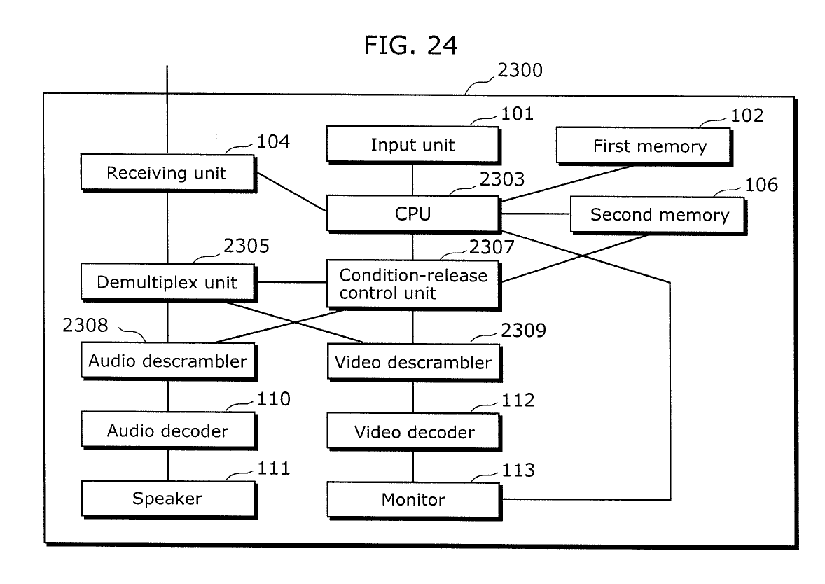

An embodiment of a digital television system including the conditional access apparatus of the present invention shall be described with reference to the drawings. FIG. 24 is a block diagram showing the relationship of constituent elements making up a digital television 2300, and includes an input unit 101, a first memory 102, a CPU 2303, a receiving unit 104, a demultiplex unit 2305, a second memory 106, a condition-release control unit 2307, an audio descrambler 2308, a video descrambler 2309, an audio decoder 110, a speaker 111, a video decoder 112, and a monitor 113. Since constituent elements having the same numerical reference as that in the first embodiment have the same function as in the first embodiment, their description shall be omitted.

The CPU 2303 has approximately the same function as the CPU 103. The difference is that, in the first embodiment, the identifiers of the audio data and video data are provided to the TS decoder 108, whereas in the second embodiment, they are provided to the demultiplex unit 2305. Other functions are the same.

The demultiplex unit 2305 receives identifiers of audio data and video data from the CPU 2303, in addition to the functions of the demultiplex unit 105 in the first embodiment. The demultiplex unit 2305 performs filtering based on the received identifiers, and passes the audio data to the audio descrambler 2308 and the video data to the video descrambler 2309.

The condition-release control unit 2307 passes information including a key to the audio descrambler 2308 and the video descrambler 2309.

The audio descrambler 2308 descrambles (decrypts) the received encrypted audio data, and passes the result to the audio decoder 110.

The video descrambler 2309 descrambles (decrypts) the received encrypted video data, and passes the result to the video decoder 112.

Note that the following applications are possible throughout the first and second embodiments.

Packaging which embeds plural constituent elements into one LSI is possible.

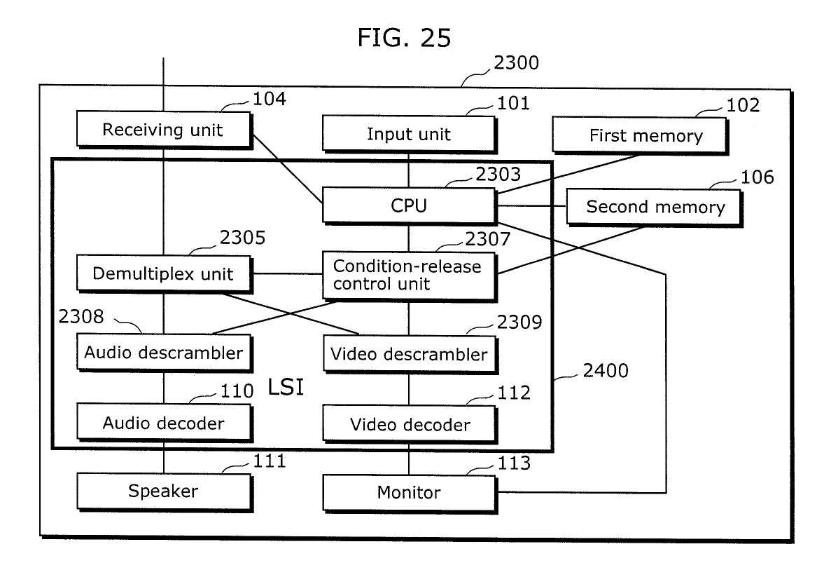

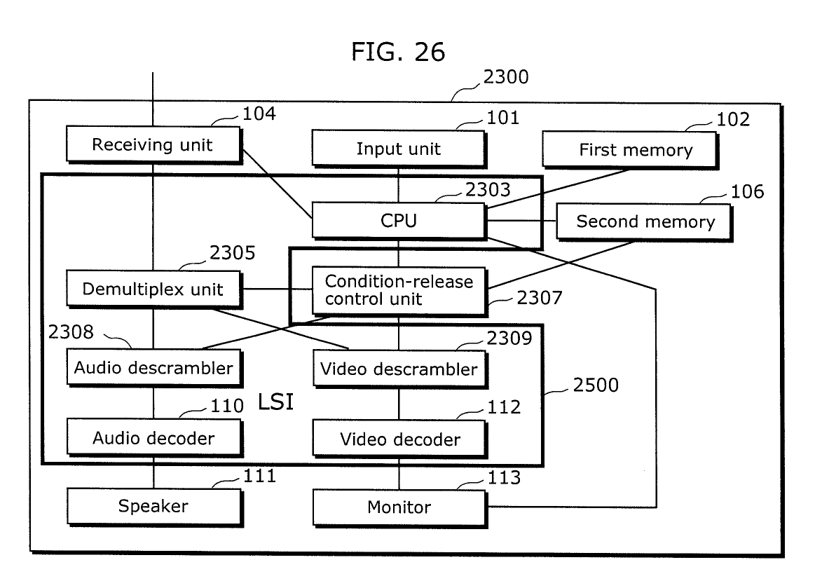

FIG. 25 shows that, in the second embodiment, the CPU 2303, the demultiplex unit 2305, the condition-release control unit 2307, the audio descrambler 2308, the video descrambler 2309, the audio decoder 110, and the video decoder 112 can be packaged into one LSI 2400. Alternatively, as shown in FIG. 26, the CPU 2303, the demultiplex unit 2305, the audio descrambler 2308, the video descrambler 2309, the audio decoder 110, and the video decoder 112 can be packaged into one LSI 2500. In addition, it is also possible not to include one or a plurality of the constituent elements among the constituent elements included in the LSI 2500.

Likewise, it is also possible to package plural constituents into one LSI in the first embodiment.

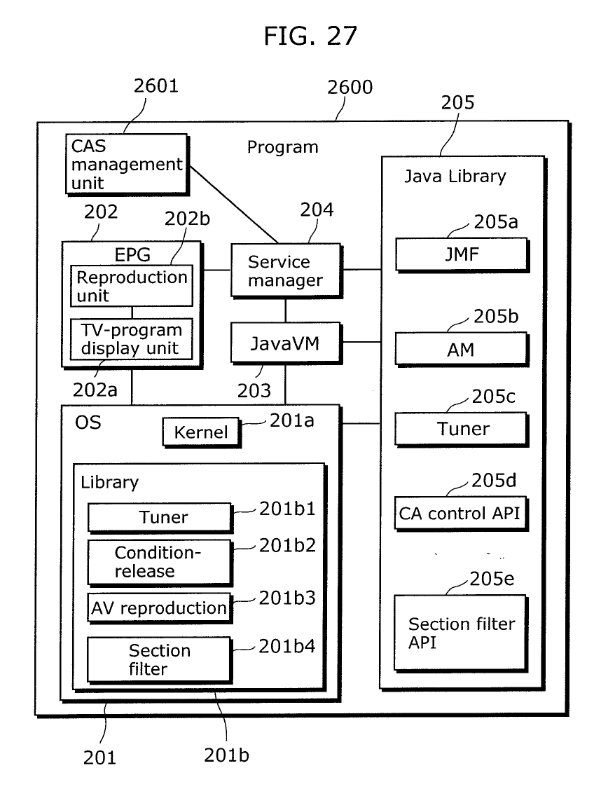

Furthermore, in the present embodiment, it is possible to add a CAS management unit 2601. FIG. 27 is a configuration diagram of a digital television 2600 including a CAS management unit 2601 which performs CAS vendor-related management. The service manager 204 stores the CA control application together with the information of XCAIT in the second memory 106. In the case where a viewer relocates and the same receiver is to be used in a broadcasting environment using a different CAS, it is possible to recognize that the receiver is in a different broadcasting environment through the comparison, by the CAS management unit 2601, of the identifier of the CAS vendor of the CA control application indicated in the XCAIT and the identifier of the CAS vendor held within the receiver. The CAS management unit 2601 can display a message in the monitor 113 that, due to the relocation, a new contract is required for the subscription viewing.

Furthermore, in the present embodiment describes the Java™ VM 203, the Java™ library 205, the condition-release unit 107, the CA control application 910 are described as being included within the terminal. However, the structure need not be limited to such, and their essentiality may be stored in a portable recording medium (for example, recording mediums such as a semiconductor memory such as an optical recording medium, a compact flash™, and SD card memory) and operation made possible by reading such stored information.

In addition, when a user buys a new receiver and views a broadcast, the CAS management unit 2601 displays, on the monitor 113, what paid broadcasts are available, by obtaining the information in the XCAIT, and thereby making it possible to notify the user of a system that can be entered into contract.

### INDUSTRIAL APPLICABILITY

The condition-release apparatus according to the present invention is mainly used in a digital television but can also be used in a mobile phone, a portable terminal, and an in-car terminal that can receive a digital television broadcast. Furthermore, the condition-release apparatus according to the present invention can also be used in a personal computer, and the like, which receives audio/video delivery which makes use of the Internet.

1-8. (canceled)

9. A Java conditional access apparatus comprising:
a descramble circuit which descrambles an encrypted broadcast content using corresponding key information, the encrypted broadcast content being included in a broadcast signal;
a key generation information obtainment library which obtains key generation information from the broadcast signal according to a specified method, the key generation information being necessary for generating the key information;
a condition-release control unit operable to generate the corresponding key information using the key generation information, and to pass the generated corresponding key information to said descrambler;
a Java VM which executes a CA control Java program and an other Java program, the CA control Java program: specifying, to said key information obtainment library, a method for obtaining the key generation information stored in the broadcast signal; requesting obtainment of the key generation information; obtaining the key generation information; providing the obtained key generation information to said condition-release control unit; and instructing descrambling by instructing key information;
a storage unit in which the CA control Java program is stored,
a channel reproduction starting unit operable to receive, from the Java program, information on a channel to be reproduced, and to start reproduction of the channel which is specified;
a registration unit operable to register a callback function for enabling the CA control Java program to receive information on the channel to be reproduced; and
a notification unit operable to call the callback function registered in said registration unit, and to notify said CA control Java program of information on the specified channel to be reproduced, when said channel reproduction starting unit starts reproduction of the channel.

10. The Java conditional access apparatus according to claim 9, further comprising
a cancellation unit operable to cancel the callback function received by said registration unit,
wherein the registration is cancelled when a request for canceling the registration is received from the CA control Java program executed by said Java VM.

11. The Java conditional access apparatus according to claim 9, further comprising
a right checking unit operable to check whether or not the CA control Java program has a right to call said condition-release control unit,
wherein the call to the API from the CA control Java program is rejected depending on a judgment of said right checking unit.

12. The Java conditional access apparatus according to claim 9,
wherein said descramble circuit functions using a semiconductor integrated circuit.

13. The Java conditional access apparatus according to claim 9, further comprising
a first download unit operable to receive CA control Java program definition information defining the CA control Java program, to obtain the CA control Java program according to the CA control Java program definition information, and to store the obtained CA control Java program in said storage unit.

14. The Java conditional access apparatus according to claim 9,
wherein, when the CA control Java program definition information is changed, said download unit is operable to obtain a new CA control Java program according to the changed CA control Java program definition information, and to store the new CA control Java program in said storage unit, and
said Java conditional access apparatus further comprises
a CA control program control unit operable to stop the CA control Java program currently being executed, and to activate the new CA control Java program stored in said storage unit.

15. The Java conditional access apparatus according to claim 14, further comprising
a CAS management unit operable to notify a user when the CA control Java program definition information is changed.

16. The Java conditional access apparatus according to claim 9,
wherein said condition-release control unit is configured of a secure microprocessor into which software is downloaded and executed so as to implement functions of said condition-release control unit.

17. The Java conditional access apparatus according to claim 10, further comprising
a right checking unit operable to check whether or not the CA control Java program has a right to call said condition-release control unit,
wherein the call to the API from the CA control Java program is rejected depending on a judgment of said right checking unit.

18. The Java conditional access apparatus according to claim 13,
wherein, when the CA control Java program definition information is changed, said download unit is operable to obtain a new CA control Java program according to the changed CA control Java program definition information, and to store the new CA control Java program in said storage unit, and
said Java conditional access apparatus further comprises
a CA control program control unit operable to stop the CA control Java program currently being executed, and to activate the new CA control Java program stored in said storage unit.

19. The Java conditional access apparatus according to claim 18, further comprising
a CAS management unit operable to notify a user when the CA control Java program definition information is changed.
